(19) United States
(12) Patent Application Publication
(10) Pub. No.: US 2025/0370277 A1
(43) Pub. Date: Dec. 4, 2025

(54) Reading Lens Attachment

(71) Applicant: Edwin E. Stevens, Onaway, MI (US)

(72) Inventor: Edwin E. Stevens, Onaway, MI (US)

(21) Appl. No.: 19/225,267

(22) Filed: Jun. 2, 2025

Related U.S. Application Data
(60) Provisional application No. 63/655,619, filed on Jun. 4, 2024.

(51) Int. Cl. G02C 7/08; G02B 1/11; G02B 1/18; G02C 9/00

(52) U.S. Cl. CPC G02C 7/086; G02B 1/11; G02B 1/18; G02C 9/00

(57) ABSTRACT

An add-on reading lenses device is disclosed that adds reading lenses to any type of eyewear. The add-on reading lenses device provides users with a reading lens attachment for sunglasses, protective eyewear, and much more. The add-on reading lenses device comprises a body component comprising a front surface and rear surface, an adhesive component and a storage component comprising a locking mechanism. The device eliminates the need to purchase and travel with several pairs of glasses. Further, the device allows users to only utilize one pair of glasses for various reasons including reading, work protection and sun protection.

### CROSS-REFERENCE TO RELATED APPLICATION

The present application claims priority to, and the benefit of, U.S. Provisional Application No. 63/655,619, which was filed on Jun. 4, 2024, and is incorporated herein by reference in its entirety.

### FIELD OF THE INVENTION

The present invention relates generally to the field of glasses lenses. More specifically, the present invention relates to an improved reading lens attachment for glasses that may be applied to various types of glasses. Accordingly, this disclosure makes specific reference thereto the present invention. Nonetheless, it is to be appreciated that aspects of the present invention are also equally applicable to other like applications, devices and methods of manufacture.

### BACKGROUND

By way of background, this invention relates to improvements in attachment lenses for glasses. Generally, many individuals require the use of reading glasses at some point throughout their lives. However, transporting multiple pairs of glasses is difficult for many people. Further, this leads to users becoming frustrated when they cannot see while doing activities. This situation forces reading glasses users to carry multiple pairs of glasses to meet their vision needs and to accommodate all environments.

Additionally, there are times when users would like to wear reading glasses while in the sun or at work. However, most reading glasses do not provide protection against UV rays or external elements. This forces users to carry multiple types of glasses. Further, prescription sunglasses and work glasses are expensive and only provide a single use.

Accordingly, there is a demand for an improved reading glasses lens that can be applied to various types of eyewear. More particularly, there is a demand for add-on reading lenses that can be transferred to various type of eyewear, eliminating the need to carry several pairs of glasses.

Therefore, there exists a long-felt need in the art for an add-on reading lenses device that provides users with a reading lens attachment for sunglasses, protective eyewear, single prescription glasses, and much more. There is also a long-felt need in the art for an add-on reading lenses device that allows the user the benefit of being able to read small text while using other eyewear. Further, there is a long-felt need in the art for an add-on reading lenses device that utilizes a light adhesive to stick the lens to the eyewear without ruining the eyewear lenses. Moreover, there is a long-felt need in the art for a device that eliminates the need to purchase and travel with multiple pairs of glasses. Finally, there is a long-felt need in the art for an add-on reading lenses device that saves time, effort, and energy for anyone who needs reading glasses.

The subject matter disclosed and claimed herein, in one embodiment thereof, comprises an add-on reading lenses device. The device is an adhesive reading lens attachment that provides reading lenses for any variety of eyewear. The add-on reading lenses device comprises a body component with a front surface and a rear surface. Further, an adhesive component is comprised on the front surface and rear surface. Additionally, users can attach either the front surface or the rear surface using the adhesive component to the desired eyewear. Further, the device is manufactured of a pliable material to fit the shape of a plurality of eyewear lenses. The device also includes a storage component that allows the device to be transported and stored when not in use. Accordingly, the device allows users to utilize reading lenses while using other eyewear. The device accounts for various prescriptions to meet the needs of all types of sight.

In this manner, the add-on reading lenses device of the present invention accomplishes all of the forgoing objectives and provides users with a device that attaches reading lenses to a variety of eyewear. The device is a pliable pair of lenses that adheres to a plurality of eyewear. The device comprises a storage component to prevent users from transporting multiple pairs of types of eyewear.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an add-on reading lenses device. The device is an adhesive reading lens attachment that provides reading lenses for any variety of eyewear. The add-on reading lenses device comprises a body component with a front surface and a rear surface. Further, an adhesive component is comprised on the front surface and rear surface. Additionally, users can attach either the front surface or the rear surface using the adhesive component to the desired eyewear. Further, the device is manufactured of a pliable material to fit the shape of a plurality of eyewear lenses. The device also includes a storage component that allows the device to be transported and stored when not in use. Accordingly, the device allows users to utilize reading lenses while using other eyewear. The device accounts for various prescriptions to meet the needs of all types of sight.

In one embodiment, the add-on reading lenses device is comprised, at a minimum, of the following components: a body component comprising a front surface and a rear surface, an adhesive component, and a storage component comprising a locking mechanism. Optional items may be added to create additional functionality, as needed.

In one embodiment, the body component is most often formed in a small rectangular shape to fit multiple shapes and sizes of glasses. In some instances, the body component can be made of flexible materials such as vinyl or plastic, or any material as known in the art. The material that the body component is comprised of provides a variety of vision prescriptions. Additionally, the add-on reading lenses device may be attached to a plurality of eyewear by the front surface or rear surface of the body of the device.

In one embodiment, the body component comprises an adhesive component. Additionally, a mild adhesive could be used to stick the device to the desired pair of eyewear. In another embodiment, a vinyl material is used to create a natural adhesion to the desired pair of eyewear. Furthermore, the adhesive component used should not leave a residue on the glass's lenses.

In one embodiment, the add-on reading lenses device comprises a storage component. Further, the storage component is preferably made of a durable plastic material or other material as known in the art. The storage component should make storing and transporting the add-on reading lenses easy and efficient. Additionally, the storage component should allow the device to be transferred between various pairs of glasses. Further, the storage component comprises a locking mechanism to prevent the add-on reading lenses device from becoming lost or being removed from the storage component during storage and travel.

In one embodiment, all portions of the present invention are fully enclosed and able to be quickly and easily wiped down and disinfected.

In one embodiment, a method of attaching and using the add-on reading lenses device is disclosed. The method includes the steps of providing an add-on reading lenses device comprising a body component comprising a front surface and rear surface, an adhesive component, and a storage component comprising a lock mechanism. The method also comprises securing the device on the desired pair of glasses lenses using the adhesive component. The method also comprises the user placing the pair of glasses on the user's face. The method also comprises the user looking through the add-on reading lenses.

In yet another embodiment, another method of using and storing the add-on reading lenses device is disclosed. The method includes the steps of providing an add-on reading lenses device comprising a body component comprising a front surface and rear surface, an adhesive component, and a storage component comprising a lock mechanism. The method also comprises securing the device on the desired pair of glasses lenses using the adhesive component. The method also comprises the user placing the pair of glasses on the user's face. The method also comprises the user looking through the add-on reading lenses. The method also comprises the user removing the add-on reading lenses from the glasses. The method also comprises the user placing the add-on reading lenses into the storage component. Finally, the method comprises securing the add-on reading lenses device in the storage component for transportation using the locking mechanism.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the add-on reading lenses device of the present invention being applied to a pair of glasses in accordance with the disclosed architecture;

FIG. 2 illustrates a perspective view of one embodiment of the add-on reading lenses device of the present invention being removed from a pair of glasses in accordance with the disclosed architecture;

FIG. 3 illustrates a perspective view of one embodiment of the add-on reading lenses device of the present invention accommodating different types of glasses in accordance with the disclosed architecture;

FIG. 4 illustrates a flowchart showing a method of attaching and using the add-on reading lenses device in accordance with the disclosed architecture; and

FIG. 5 illustrates a flowchart showing another method of using and storing the add-on reading lenses device in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for an add-on reading lenses device that provides users with a reading lens attachment for sunglasses, protective eyewear, single prescription glasses, and much more. There is also a long-felt need in the art for an add-on reading lenses device that allows the user the benefit of being able to read small text while using other eyewear. Further, there is a long-felt need in the art for an add-on reading lenses device that utilizes a light adhesive to stick the lens of the eyewear without ruining the eyewear lenses. Moreover, there is a long-felt need in the art for a device that eliminates the need to purchase and travel with multiple pairs of glasses. Finally, there is a long-felt need in the art for an add-on reading lenses device that saves time, effort, and energy for anyone who needs reading glasses.

The present invention, in one exemplary embodiment, is a novel add-on reading lenses device. The device allows various types of glasses to be transformed into reading glasses. The device is applied to the outside or inside of the lens of the glasses to improve the user's sight while reading small text. The add-on reading lenses device comprises a body component with a front surface and a rear surface. Further, an adhesive component is comprised on the front surface and rear surface. Additionally, users can attach either the front surface or the rear surface using the adhesive component to the desired eyewear. Further, the device is manufactured of a pliable material to fit the shape of a plurality of eyewear lenses. The device also includes a storage component comprising a locking mechanism that allows the device to be transported and stored when not in use. The present invention also includes the steps of applying and storing the add-on reading lenses device. The device may be applied to various types of eyewear using an adhesive component on the outside or inside of the glasses. The device is easily removed from the eyewear without harming the lenses and being forced to replace them due to scratches or smudges. The add-on reading lenses device is easily stored and prevents users from having to carry multiple pairs of glasses. Further, the device may have a static tape type material instead of an adhesive component.

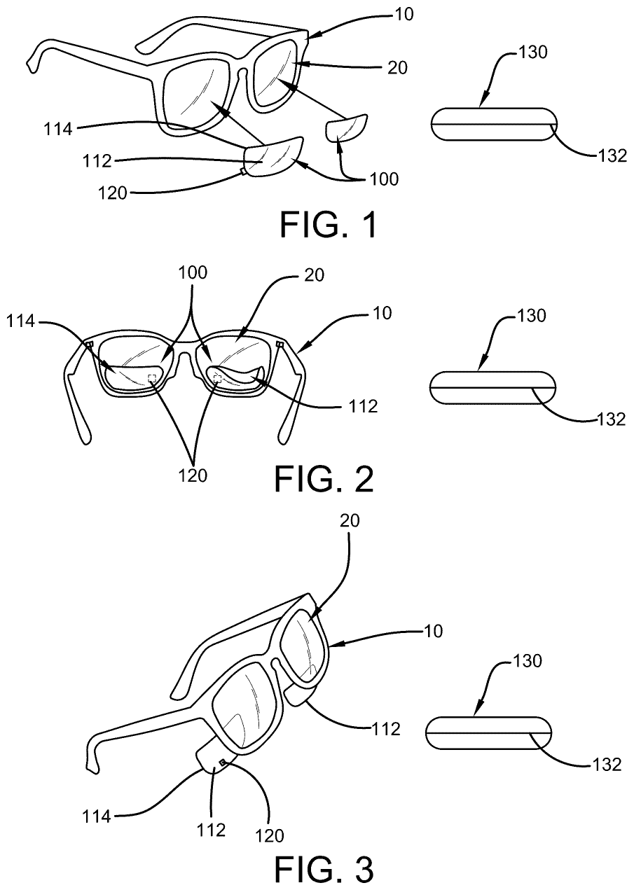

Referring initially to the drawings, FIG. 1 illustrates a perspective view of one embodiment of the add-on reading lenses device 100 of the present invention. In the present embodiment, the add-on reading lenses device 100 provides a glasses lens attachment designed to allow various types of glasses 10 to accommodate a reading prescription. The add-on reading lenses device 100 is comprised of a body component 110 with a front surface 112 and a rear surface 114, an adhesive component 120, and a storage component 130 that includes at least one locking mechanism 132. The device 100 enables users to attach the add-on reading lenses device 100 to any pair of glasses lenses 12, reducing the need to transport and store multiple pairs of glasses 10.

The body component 110 is configured to provide a versatile and user-friendly means of converting ordinary glasses 10 into reading glasses with bi-focal capabilities. This conversion allows for enhanced functionality without permanently altering the original glasses 10. The body component 110 is designed with flexibility to accommodate glasses lenses 12 of varying shapes and sizes. While the preferred embodiment of the body component 110 is a rectangular shape, alternative configurations, such as oval, circular, or custom contoured shapes, can also be employed depending on user preferences and specific eyewear designs. The thickness of the body component 110 is optimized to balance durability and minimal weight, ensuring comfort for the user. The body component 110 may be comprised of lightweight, durable materials such as polycarbonate, acrylic, or high-impact polystyrene. In alternative embodiments, the body 110 may incorporate flexible polymers like thermoplastic polyurethane (TPU) or silicone to enhance adaptability to curved or irregularly shaped eyewear lenses.

The front surface 112 and rear surface 114 of the body component 110 provide structural support and interfaces for other components. These surfaces 112, 114 may be comprised of anti-reflective coatings, scratch-resistant finishes, or other optical treatments/materials to ensure clear vision and protect the device 100 during extended use.

At least one adhesive component 120 is positioned on the rear surface 114, and optionally on the front surface 112, enabling attachment to the interior or exterior surfaces of eyewear lenses 12. This configuration allows the device 100 to be used with a wide range of glasses 10, including prescription eyewear, sunglasses, and safety goggles. The adhesive component 120 is preferably comprised of a reusable vinyl or silicone-based material that provides a secure bond to the eyewear lenses 12 without leaving residue or causing damage upon removal. Additionally, the adhesive material exhibits high resistance to environmental factors such as heat, moisture, and ultraviolet (UV) light, ensuring long-term reliability. Variations of the adhesive component 120 may include electrostatic adhesion or micro-suction fasteners for users who require non-permanent attachment solutions. The adhesive component 120 further enables secure placement of the add-on reading lenses device 100 within the storage component 130 during transport or storage. This dual-purpose functionality enhances the usability and longevity of the device 100.

The storage component 130 is provided to facilitate the safe transportation and storage of the add-on reading lenses 110. Constructed from a durable plastic material, such as polycarbonate or ABS, the storage component 130 protects the body 110 from environmental damage, such as impacts, scratches, or exposure to dirt and moisture. The storage component 130 is designed to accommodate the body 110 securely using the adhesive component 120. This ensures that the device 100 remains in place within the storage component 130 even during movement or vibration. The storage component 130 includes at least one locking mechanism 132 to ensure that the device 100 remains enclosed when not in use. The locking mechanism 132 is preferably a hook-and-clasp design but may also incorporate other mechanisms, such as magnetic closures, snap locks, or twist locks, as appropriate for the intended use case. Variants of the storage component 130 may include compartments for storing multiple devices 100, cleaning wipes, or other accessories.

Additionally, the design of the add-on reading lenses device 100 includes optional features for enhanced functionality. The body 110 may be manufactured with multiple magnification levels, providing incremental reading assistance for users with varying prescriptions. The body 110 may also be available in clear or tinted variations to reduce glare or enhance aesthetic appeal. The body 110 may also be comprised of an anti-fog and hydrophobic coatings may be applied to the front surface 112 and rear surface 114 to improve performance in humid environments or during strenuous activities.

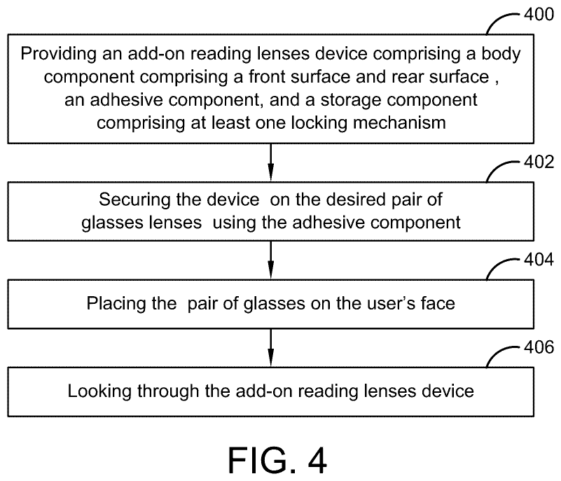

FIG. 4 illustrates a flowchart showing a method of attaching and using the add-on reading lenses device 100. The method includes the steps of at 400, providing an add-on reading lenses device 100 comprising a body component 110 comprising a front surface 112 and rear surface 114, an adhesive component 120, and a storage component 130 comprising at least one locking mechanism 132. The method also comprises at 402, securing the device 100 on the desired pair of glasses lenses 12 using the adhesive component 120. The method also comprises at 404, placing the pair of glasses 10 on the user's face. Finally, the method comprises at 406, looking through the add-on reading lenses device 100.

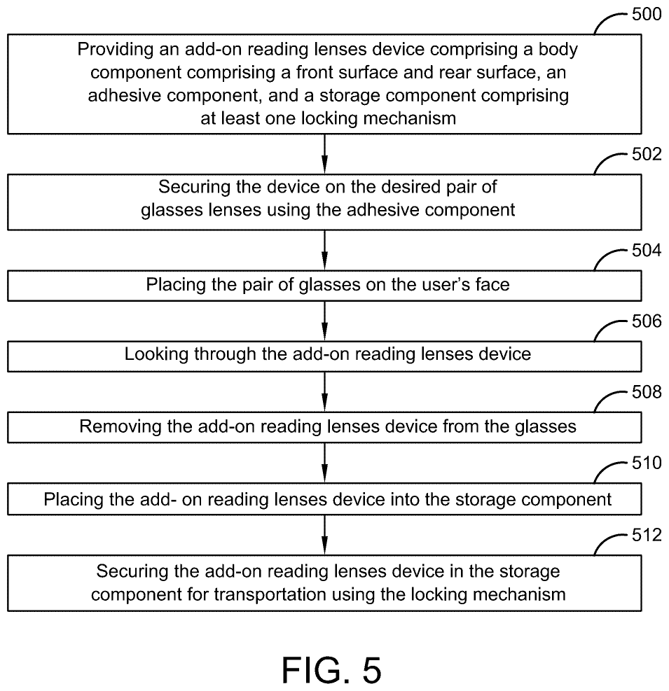

FIG. 5 illustrates a flowchart showing another method of using and storing the add-on reading lenses device 100. The method includes the steps of at 500, providing an add-on reading lenses device 100 comprising a body component 110 comprising a front surface 112 and rear surface 114, an adhesive component 120, and a storage component 130 comprising at least one locking mechanism 132. The method also comprises at 502, securing the device 100 on the desired pair of glasses lenses 12 using the adhesive component 120. The method also comprises at 504, placing the pair of glasses 10 on the user's face. The method comprises at 506, looking through the add-on reading lenses device 100. The method also comprises at 508, removing the add-on reading lenses device 100 from the glasses 10. The method also comprises at 510, placing the add-on reading lenses device 100 into the storage component 130. Finally, the method also comprises at 512, securing the add-on reading lenses device 100 in the storage component 130 for transportation using the locking mechanism 132.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “add-on reading lenses device”, “reading lenses device”, “heated outdoor ceiling fan”, and “device” are interchangeable and refer to the heated ceiling fan device 100 of the present invention.

Notwithstanding the forgoing, the add-on reading lenses device 100 of the present invention can be of any suitable size and configuration as is known in the art without affecting the overall concept of the invention, provided that it accomplishes the above stated objectives. One of ordinary skill in the art will appreciate that the add-on reading lenses device 100 as shown in FIGS. 1-5 is for illustrative purposes only, and that many other sizes and shapes of the add-on reading lenses device 100 are well within the scope of the present disclosure. Although the dimensions of the add-on reading lenses device 100 are important design parameters for user convenience, the add-on reading lenses device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An add-on reading lenses device comprising:
a body comprised of a front surface and a rear surface, wherein the body is configured to provide bi-focal reading functionality;
an adhesive component positioned on the rear surface of the body; and
a storage component configured to secure the body, the storage component comprised of a locking mechanism to retain the body within the storage component.

2. The add-on reading lenses device of claim 1, wherein the adhesive component is comprised of a reusable vinyl.

3. The add-on reading lenses device of claim 1, wherein the adhesive component is comprised of a silicone-based adhesive.

4. The add-on reading lenses device of claim 1, wherein the adhesive component is comprised of a micro-suction fastener.

5. The add-on reading lenses device of claim 1, wherein the adhesive component is comprised of an electrostatic adhesion fastener.

6. The add-on reading lenses device of claim 1, wherein the front surface and the rear surface are comprised of an anti-reflective material.

7. The add-on reading lenses device of claim 1, wherein the front surface and the rear surface are comprised of a scratch-resistant material.

8. The add-on reading lenses device of claim 1, wherein the front surface and the rear surface are comprised of an anti-fog material.

9. The add-on reading lenses device of claim 1, wherein the front surface and the rear surface are comprised of a hydrophobic material.

10. The add-on reading lenses device of claim 1, wherein the body is comprised of a flexible material.

11. An add-on reading lenses device comprising:
a magnifying body comprised of a front surface and a rear surface, wherein the body is configured to provide bi-focal reading functionality;
an adhesive component; and
a storage component configured to secure the body, the storage component comprised of a locking mechanism to retain the body within the storage component.

12. The add-on reading lenses device of claim 11, wherein the body is comprised of a tinted material.

13. The add-on reading lenses device of claim 11, wherein the body is comprised of a flexible material.

14. The add-on reading lenses device of claim 11, wherein the adhesive component is comprised of a reusable vinyl.

15. The add-on reading lenses device of claim 11, wherein the adhesive component is comprised of a silicone-based adhesive.

16. The add-on reading lenses device of claim 11, wherein the adhesive component is comprised of a micro-suction fastener.

17. The add-on reading lenses device of claim 11, wherein the adhesive component is comprised of an electrostatic adhesion fastener.

18. The add-on reading lenses device of claim 11, wherein the front surface and the rear surface are comprised of an anti-reflective material.

19. The add-on reading lenses device of claim 11, wherein the front surface and the rear surface are comprised of a scratch-resistant material.

20. A method of using an add-on reading lenses device, the method comprising the following steps:
providing an add-on reading lenses device comprised of a body with a front surface and a rear surface, an adhesive component, and a storage component comprised of a locking mechanism;
securing the body to a lens of a pair of glasses using the adhesive component;
placing the pair of glasses on a user's face; and
viewing through the add-on reading lenses device.
